(19) United States
(12) Patent Application Publication
(10) Pub. No.: US 2006/0112100 A1
(43) Pub. Date: May 25, 2006

(54) Document management apparatus, document management method, and document management program

(75) Inventors: Harunobu Maeda, Shizuoka-ken (JP); Hiroki Miyachi, Kanagawa-ken (JP); Yoshiko Suenaga, Kanagawa-ken (JP); Kouichi Mase, Chiba-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/264,231

(22) Filed: Oct. 31, 2005

(30) Foreign Application Priority Data
Nov. 25, 2004 (JP) 2004-340707

(51) Int. Cl. G06F 17/30

(52) U.S. Cl. 707/8

(57) ABSTRACT

Provided are a document management device, a document management method, and a document management program that are capable of providing a user with notification that an updated shared file has been stored. The present invention refers to a document management apparatus that manages a shared document to which access is permitted to a plurality of users. The document management apparatus has a shared document management section which, when a shared file designated by a user has been checked in, provides check-in notification, to an address designated by the user, that the shared file has been checked in.

### BACKGROUND OF THE INVENTION

1. Field of the Invention

The present invention relates to a document management apparatus, a document management method, and a document management program, which are applicable to, for example, a document management system that permits a plurality of users to share a document data file.

2. Description of Related Art

A document management system has been recently proposed which is connectable to a network and which permits a plurality of users to share a document data file (see Japanese Patent Application Laid-Open No. 2003-131919).

Conventionally, a document management server that manages document data files (hereinafter referred to as files) for documents or the like acquires a file designated by the user, saves this file in a shared folder, and manages the file as a shared file. Upon receiving an edit request or a reference request from the user, the document management server retrieves a requested shared file from a corresponding shared holder, and then provides the file to the user side.

In this case, the state in which the user side is permitted to perform writing and editing on a shared file for which the user side has made an access request is referred to as check-out.

After editing and the like are performed on the shared file on the user side, in response to user's designation, the document management server acquires an updated shared file which has been subjected to the editing and the like, and then saves the shared file again in the shared folder. This operation permits the updated shared file to be saved and shared.

In this case, the state in which editing and the like are completed whereby access to a shared file being checked out ends is referred to as check-in.

Since a shared file is shared by a plurality of users, there arises a possible competition between them for file acquisition when a plurality of edit requests or the like for the same file have been made to the document management server. Thus, to avoid the competition for file acquisition, the conventional document management server provides the shared file to the user who has made the edit request first, and, when thereafter a different user has made an edit request while the shared file is being checked out, the conventional document management server permits the different user only to make reference to the shared file.

However, as described above, the user, who has made the edit request while the shared file is being checked out, is only permitted to make reference to the shared file; therefore, the user is obviously unable to know contents of an updated file being edited by the former user. In addition, even if the different user tries to observe the contents of the updated file after the editing performed by the former user ends, the different user has no idea when the editing operation performed by the former user ends and when the file is to be checked in, thus leading to a problem such that the updated file cannot be referenced or updated timely.

### SUMMARY OF THE INVENTION

It is an object of the present invention to provide, in a document management system that permits a plurality of users to share a file, a document management apparatus, a document management method, and a document management program that can, when another request has been made for a file being checked out, provide a user who has made this request with notification that the file has been checked in.

According to one aspect of the invention, a document management apparatus that manages a shared document to which access is permitted to a plurality of users, has a shared document management section which, when a shared file designated by a user has been checked in, provides check-in notification, to an address designated by the user, that the shared file has been checked in.

According to another aspect of the invention, in a document management method that manages a shared file to which access is permitted to a plurality of users, when a shared file designated by a user has been checked in, a shared document management section provides check-in notification, to an address designated by the user, that the shared file has been checked in.

According to still another aspect of the invention, in a document management program for causing a document management apparatus which manages a shared file to which access is permitted to a plurality of users to function as a shared document management section which, when a shared file designated by a user has been checked in, provides check-in notification, to an address designated by the user, that the shared file has been checked in.

### BRIEF DESCRIPTION OF THE DRAWINGS

FIG. 1 is an overall block diagram showing the main configuration of a document management system of an embodiment according to the present invention;

FIG. 2 is a block diagram showing the inner configuration and functions of a document management apparatus of the embodiment;

FIG. 3 is a diagram showing an example of directory structure of a document storage part of the embodiment;

FIG. 4 is a block diagram showing functions possessed by a shared document management function of the embodiment;

FIG. 5 is an illustration explaining an example of items to be specified for check-in notification setting of the embodiment;

FIG. 6 is a flowchart of operation performed by the shared document management function of the embodiment;

FIG. 7 is a flowchart of operation performed by the shared document management function of the embodiment;

FIG. 8 is an illustration explaining an example of contents of check-in notification of the embodiment; and

FIG. 9 is an illustration explaining an example of contents of check-in notification of the embodiment.

### DETAILED DESCRIPTION OF PREFERRED EMBODIMENTS

With reference to the accompanying drawings, a description will be given below on the preferred embodiment of a document management apparatus, a document management method, and a document management program according to the present invention.

### (A) Embodiment

The description on this embodiment refers to a case where the document management apparatus, the document management method, and the document management program of the invention are applied to a closed network in which a terminal, a printer, a scanner, and the like are connected together via a communication line.

### (A-1) Configuration of the Embodiment

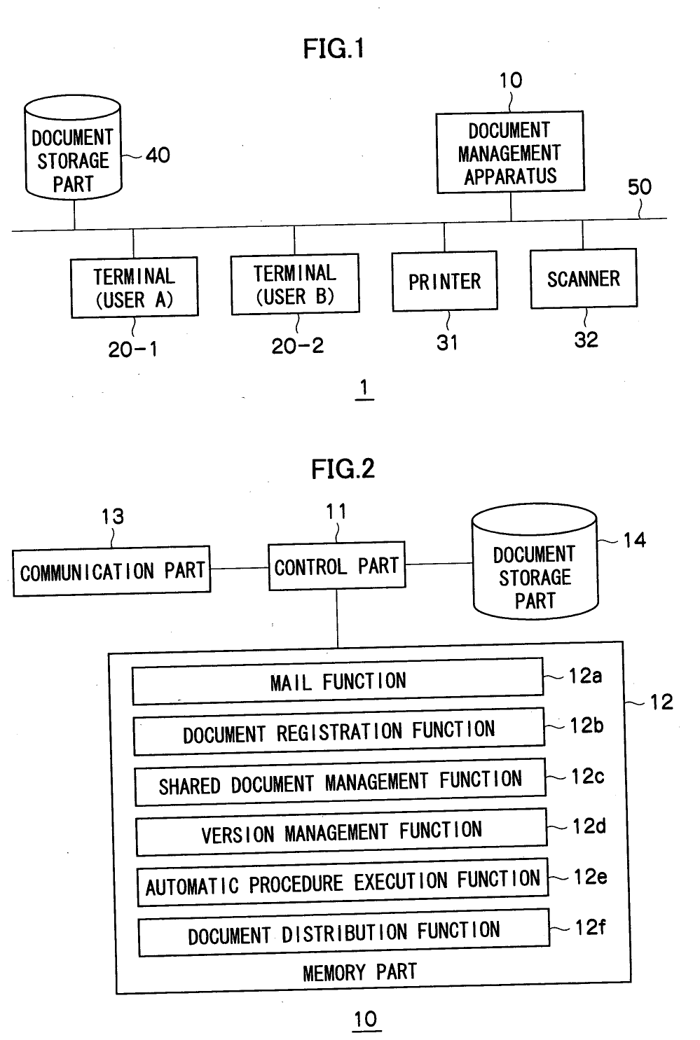

FIG. 1 is an overall block diagram showing the main configuration of a document management system according to the embodiment.

As shown in FIG. 1, a document management system 1 includes a document management apparatus 10, terminals 20-1 and 20-2, a printer 31, a scanner 32, a document storage part 40, and the like. For the description of functions which are common to the terminals 20-1 and 20-2 as a terminal, the terminal is indicated as a terminal 20.

In this embodiment, the document management system 1 forms a closed network in which the components thereof are connected to a communication line 50. Obviously, the network may be extended in such a manner as to be made open by being connected to another network via a relay apparatus having a data conversion function and the like.

The terminal 20 corresponds to, for example, a personal computer or the like, has a mail transmission-reception function, and provides various designations and requests to the document management apparatus 10 through operation by a user of the system. The terminal 20 also has functions of searching and browsing contents of a file managed by the document management apparatus 10. The terminal 20-1 is a terminal operated by a user A, and the terminal 20-2 is a terminal operated by a user B.

The printer 31, in response to a designation provided by the document management apparatus 10, the terminal 20, or the like, downloads a file stored in the document management apparatus 10, and then performs printing based on data of the downloaded file.

The scanner 32, in response to a designation provided by the document management apparatus 10, the terminal 20, or the like, scans an image to be treated as a file, and provides the scanned image as image data to the document management apparatus 10 so that the document management apparatus 10 stores the provided image as a file.

In FIG. 1, the printer 31 and the scanner 32 are provided to clarify functions of outputting and inputting file contents which are performed in the system 1. Thus, these apparatuses may be obviously replaced with other image forming apparatus or other image inputting apparatus, or a composite apparatus, for example, a MFP (Multi Function Peripheral), which integrates these apparatuses and functions.

The document management apparatus 10 is capable of executing a mail transmission-reception function, and has a document registration function, a shared document management function, a file version management function, an automatic procedure execution function, and a document distribution function to be performed in accordance with various designations and requests received from the terminal 20 through operation by the user. As long as the document management apparatus 10 is capable of performing the mail function, the document management apparatus 10 may include the mail function therein, or may use an external mail apparatus instead of including the mail function therein. The description of this embodiment is based on an assumption that the document management apparatus 10 includes the mail function therein.

The right of access to the document management apparatus 10 is provided in advance only to a user of the document management system 1. Thus, the user can access the document management apparatus 10 by exercising the right of access.

FIG. 2 is a block diagram showing the inner configuration and functions of the document management apparatus 10. As shown in FIG. 2, the document management apparatus 10 has a control part 11, a memory part 12, a communication part 13, and a document storage part 14.

The control part 11 corresponds to, for example, a CPU or the like, and controls functions to be achieved by the document management apparatus 10. The memory part 12 corresponds to, for example, RAM, ROM, or the like, and memorizes processing programs executed by the control part 11 and data required for executing the processing programs. Main processing programs of this embodiment include a mail function 12a, a document registration function 12b, a shared document management function 12c, a version management function 12d, a automatic procedure execution function 12e, a the document distribution function 12f. The control part 11 can achieve these functions by executing the processing programs stored in the memory part 12. The processing programs executed in the document management apparatus 10 of this embodiment may be stored in a computer-readable recording medium so that the processing programs may be read by the computer for execution.

The communication part 13 achieves communication processing in a predetermined communication method under the control of the control part 11. The document storage part 14 stores registered files, and corresponds to an external memory apparatus or the like. As long as the document storage part 14 can be controlled by the control part 11, the document storage part 14 does not have to be physically located in the same apparatus.

Next, a description will be given on the functions achieved by the document management apparatus 10. As described above, the functions achieved by the document management apparatus 10 can be achieved by the control part 11 executing the processing programs stored in the memory part 12.

The mail function 12a is a function that performs transmission and reception of e-mails to and from a computer apparatus which is connected to the communication line 50 and which has a mail function. The document management apparatus 10 uses this mail function 12a to receive a designation and a request from the terminal 20, or to transmit or receive an e-mail with a file attached.

The document registration function 12b receives a registration designation (for example, a designation provided by e-mail) from the terminal 20, and registers and saves a designated file into a designated folder of the document storage part 14. For this registration, a file attached to an e-mail when the registration designation is provided from the terminal 20 may be treated as the file to be registered. Alternatively, a designated address in the document storage part 40 may be traced to acquire the designated file from the document storage part 40 for registration. The document registration function 12b is also capable of sorting files addressed to different users into respective folders provided for the users in the document storage part 14. Moreover, the document registration function 12b is a function that, in response to a designation or a request from the terminal 20, provides a registered file to the designated terminal 20 and/or the printer 31. This function permits registration (storage) of the designated file and also permits outputting of the registered file.

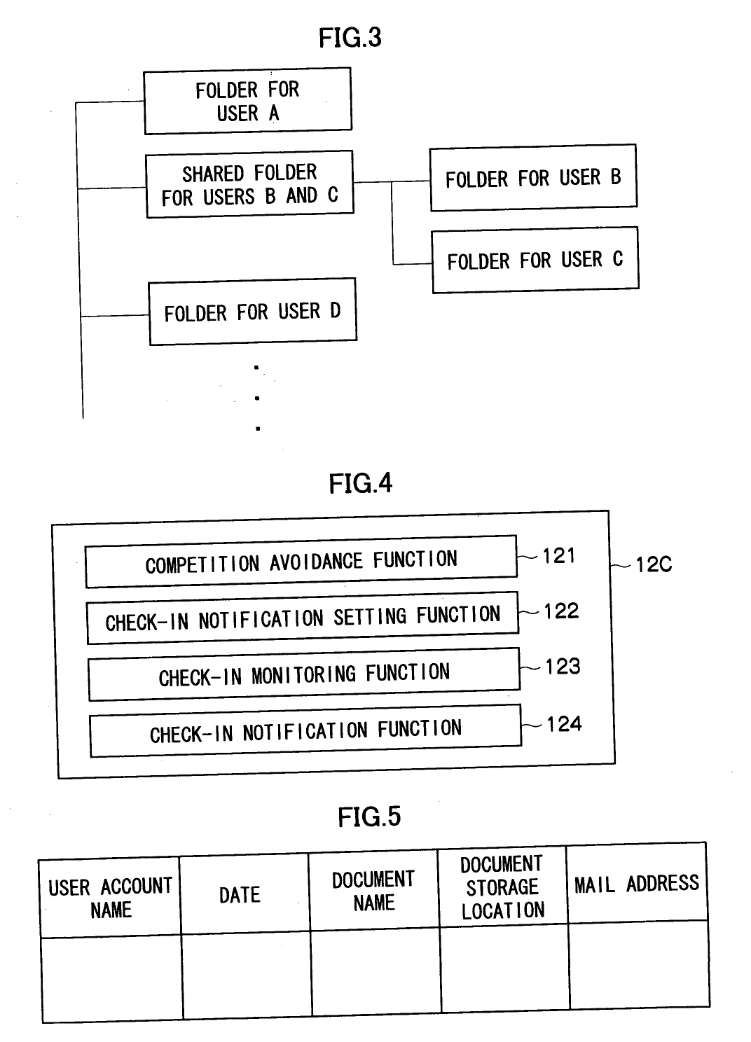

The shared document management function 12c saves a file designated by the terminal 20 into a shared holder, and then manages this file as a shared file. A shared folder may be shared by all the users, or may be shared by a plurality of specific users. Alternatively, folders may be sorted by type of file contents (for example, by operation contents). FIG. 3 shows an example of directory structure of the document storage part 14. For example, the structure as shown in FIG. 3 is adopted in which folders specific to users A to D, respectively, are provided, and, for example, when a file is to be shared by the users B and C, a shared folder for the users B and C is provided at a level higher than the respective folders specific to the users B and C. The shared document management function 12c specifies a user who is permitted to access a shared folder, and therefore accepts only access made by the specified user.

Further, the shared document management function 12c has, as shown in FIG. 4, processing programs for a competition avoidance function 121, a check-in notification setting function 122, a check-in monitoring function 123, and a check-in notification function 124.

The competition avoidance function 121 is a function that avoids competition for the same shared file when check-out requests or reference requests for the same shared file are received from a plurality of user terminals 20. When check-out requests or the like for the same shared file have been made by the plurality of user terminals 20, the competition avoidance function 121 provides the shared file to the user terminal which has made the request first, and permits the user terminal which has made the request later only to make reference to the shared file being checked out. In this way, giving priority to the user who has made the request first can avoid writing and editing processing from being simultaneously performed on the shared file.

The check-in notification setting function 122 is a function that, when a check-out request or a reference request has been made for a file being checked out, asks the terminal 20 which has made the request later whether or not check-in notification is required. The check-in notification setting function 122 is also a function that sets account information required for notification indicating that the shared file has been checked in, which is to be provided, if required, to the user when the shared file has been checked in. The check-in notification setting function 12c may also cooperate with the mail function 12a so as to ask the terminal 20 whether or not to make notification setting and acquire the setting information from the terminal 20. FIG. 5 shows an example of account information to be set for check-in notification setting. As shown in FIG. 5, the account information includes, for example, a user account name for identification of a user (for example, user identification information, such as a user ID), date of setting, a document name targeted for check-in notification, a storage location of a file for the document, a mail address of the user, and the like.

The setting information is, however, not limited to those described above, but may include, for example, yes/no information on whether or not notification indicating whether or not the file contents has been changed is required at the time of check-in notification, or yes/no information on whether or not an updated file or property information (for example, information on the updated date, the person who has updated, and the like) need to be attached at the time of check-in notification.

The check-in monitoring function 123 is a function that, when check-in notification setting has been made, monitors, based on the information on the document name and the document storage location included in the defined account information, whether or not the file has been checked in. The check-in monitoring function 123 is also a function that checks whether or not the file checked in has any updated contents. For example, the check-in monitoring function 123 compares file contents before check-out and file contents after check-in. The check-in monitoring function 123 then can determine, when there is any difference between them, that the contents has been changed, and can determine, when there is no difference between them, that the contents has not been changed.

The check-in notification function 124 is a function that, when a document (shared file) monitored by the check-in monitoring function 123 has been checked in, provides, to a mail address set as account information, an e-mail of notification that the file has been checked in. The check-in notification function has, in an e-mail text, an example sentence indicating that the file has been checked in; therefore, the check-in notification function may cooperate with the mail function 12a to transmit an e-mail. This example sentence in the e-mail text may include, for example, a sentence such as “the contents have been changed” or “the contents have not been changed”, in accordance with the determination made by the check-in monitoring function 123 on whether or not the contents has been changed. Moreover, at the time of check-in notification, an updated file or property information may be attached to an e-mail for transmission.

Next, referring back to FIG. 2, a description will be given on the version management function 12d. The version management function 12d is a function that, when a file stored has been checked out and the contents thereof has been edited and changed by a user side, manages the version of the file. In this embodiment, the version management function 12d is designed to manage the number of update operations performed on a file whose contents has been changed. Alternatively, the version management function 12d may be designed to manage the number of check-out actions made by each file, or to manage the number of usages by a user who has made a check-out request, the usage date, or the like.

The automatic procedure execution function 12e is a function that allocates a predetermined procedure to each folder, and automatically executes a procedure designated for a file stored in the folder. The predetermined procedure can be set by an engineer or a user.

For example, in a case where a procedure is set such that, when a file A is stored into a folder A, the file A is converted to text format, and then this text file A is transmitted to the terminal 20 by e-mail, this procedure can be automatically executed upon the registration of the file A into the folder A.

The document distribution function 124 is a function that, in response to a designation provided from the terminal 20, distributes by e-mail a designated file to a plurality of designated terminals 20, or distributes a designated file to a plurality of designated printers 31 or the like to thereby cause such apparatuses to produce outputs.

### (A-2) Operation of the Embodiment

Next, referring to the drawings, a description will be given on an operation of a shared document management performed by the document management apparatus 10 when a plurality of users has made check-out requests (for example, edit requests) or reference requests for the same shared document file (hereinafter referred to as shared document). The description is based on an assumption that the mutually competing users are a user A and a user B and that a request made by the user A is a former request while a request made by the user B is a latter request.

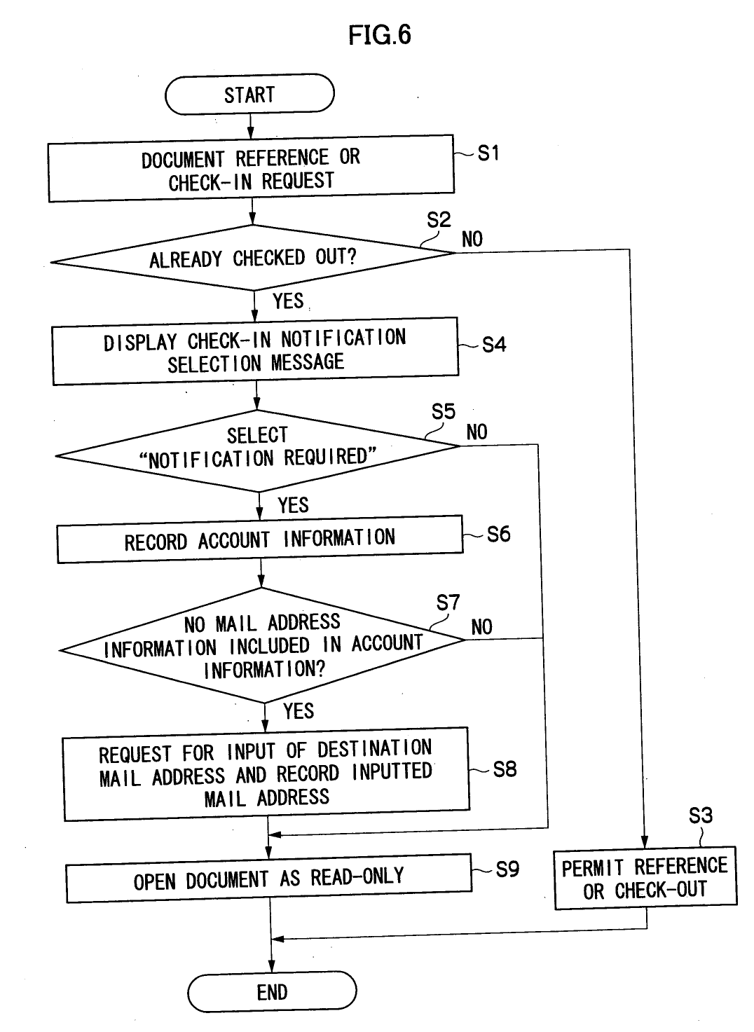

FIG. 6 is a flowchart of the operation performed by the document management apparatus 10 when the users attempt to access a shared document.

In FIG. 6, as a result of operation by the user A, the terminal 20-1 makes a check-out request to the document management apparatus 10 for a shared document (S1).

Upon the check-out request made to the document management apparatus 10 for the shared document, the document management apparatus 10 determines whether or not the requested shared document has been already checked out (S2).

Since a request made by the user A is assumed as a former request in this embodiment, the shared document has not yet been checked out; therefore, the document management apparatus 10 permits the check-out of the shared document and then provides the shared document to the terminal 20-1 (S3). As a result, the document management apparatus 10 manages the shared document, treating it as being in a checked-out state. The same operation just described above applies when the user A makes a reference request for a shared document.

Meanwhile, while the shared document is being checked out, as a result of operation by the user B, the terminal 20-2 makes a check-out request to the document management apparatus 10 for a shared document (S1).

Upon the check-out request made from the terminal 20-2 to the document management apparatus 10 for the shared document, the document management apparatus 10 determines whether or not the requested shared document has been already checked out (S2). Since a request made by the user B is assumed as a latter request in this embodiment, the document management apparatus 10 determines that the shared document has been already checked out.

At this point, the document management apparatus 10 may transmit to the terminal 20-2, for example, information such as a stored document list indicated in different colors so as to report to the user B that the shared document has been checked out.

Upon determination by the document management apparatus 10 that the shared document is being checked out, the control part 11 executes the check-in notification setting function 122 whereby a selection message asking whether or not to provide check-in notification is transmitted to the terminal 20-2, and the selection message is displayed on the terminal 20-2 (S4).

Upon receiving a response to this selection message from the user B through the terminal 20-2, the document management apparatus 10 confirms contents of the selection (S5).

At this point, upon selection by the user B that check-in notification is not to be provided, the document management apparatus 10 does not make check-in notification setting, and the control part 11 executes the competition avoidance function 121 whereby access to read-only documents is permitted (S9).

On the other hand, at this point, upon selection by the user B that check-in notification is provided, the document management apparatus 10 stores account information preset for check-in notification setting (S6).

At this point, in a case where the document management apparatus 10 is not provided with a mail function and thus an external mail apparatus is used, the following processes S7 and S8 are performed. More specifically, if the document management apparatus 10 is provided with a mail function, the mail address of the terminal 20-2 can be recognized through communication with the terminal 20-2, or this mail address can be recognized since it has been set previously. Thus, a request for inputting, at this time, the mail address of the terminal 20-2 is not required. However, if the document management apparatus 10 uses an external mail apparatus, the processes S7 and S8 are required since the mail address of the terminal 20-2 may be unknown in some cases.

At S7, the document management apparatus 10 checks contents of the set account information to determine whether or not the mail address of the terminal 20-2 is set (S7).

When the mail address is set in the account information, the document management apparatus 10 determines that an item related to check-in notification is set, and the control part 11 executes the competition avoidance function 121 whereby access to read-only documents is permitted (S9).

When the mail address is not set in the account information, the document management apparatus 10 requests the terminal 20-2 to input the mail address. Upon receiving a response including the mail address information, the document management apparatus 10 records this mail address of the terminal 20-2 (S8).

Upon the recording of the mail address into the document management apparatus 10, the control part 11 executes the competition avoidance function 121 whereby access to read-only documents is permitted (S9).

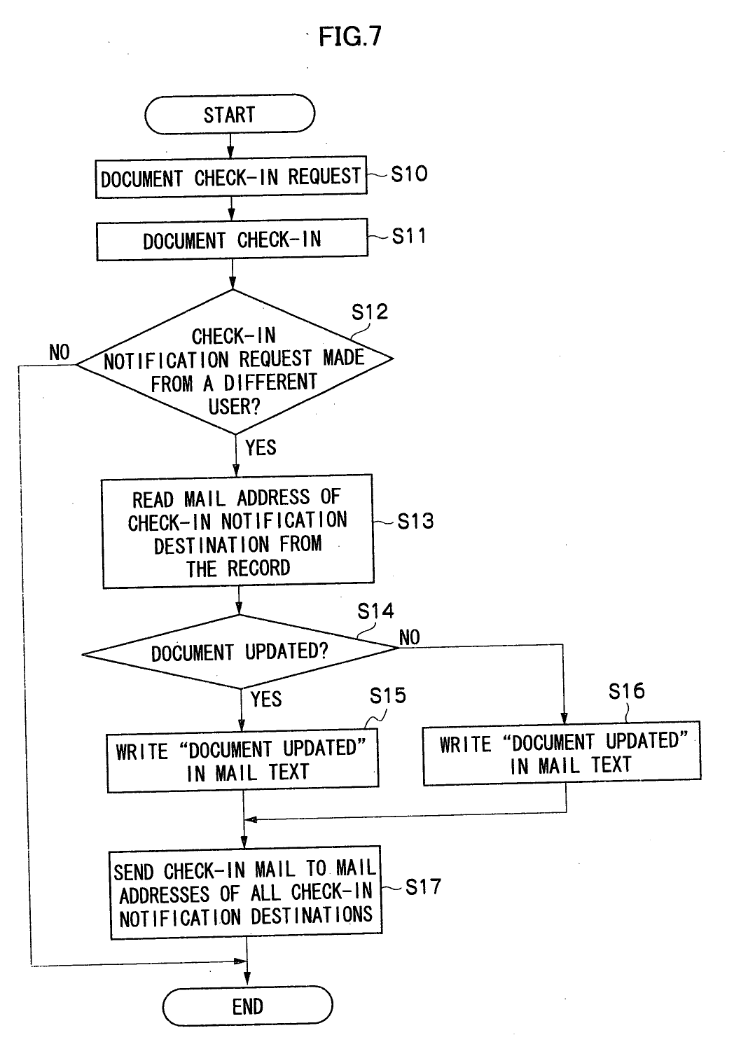

Next, referring to FIG. 7, a description will be given on an operation performed by the document management apparatus 10 when a shared document set for check-in notification has been checked in.

In FIG. 7, as a result of operation by the user A, the terminal 20-1 makes a check-in request to the document management apparatus 10 for a shared document (S10).

Upon the check-in request made from the terminal 20-1 to the document management apparatus 10 for the shared document, in the document management apparatus 10, the shared document is checked in a shared folder (S11).

In addition, upon the check-in request made for the shared document, in the document management apparatus 10, the control part 11 executes the check-in monitoring function 123 whereby it is determined whether or not the document checked in matches the document for which check-in notification is required (S12).

At this point, the document management apparatus 10 achieves this determination through comparison, on the documents names and the documents storage locations set as account information at the time of check-in notification setting, between the document checked in and the document for which the check-in notification is required.

When the document checked in is not the document set for check-in notification, the processing directly proceeds to its end.

On the other hand, when the document checked in is the document set for check-in notification, the control part 11 executes the check-in notification function 124 whereby the e-mail address is extracted from the record (S13).

Subsequently, contents of the document checked in is compared with contents of the document before checked out to determine whether or not the contents has been changed (S14).

When the document checked in has updated contents, a sentence indicating that the contents has been changed is written into the e-mail text (S15). When the contents of the document checked in has no updated contents, a sentence indicating that the contents has not been changed is written into the e-mail text (S16).

Upon completion of the writing into the e-mail text, an e-mail is transmitted which is addressed to the e-mail address of the terminal 20-2 that has been set at the time of check-in notification setting (S17).

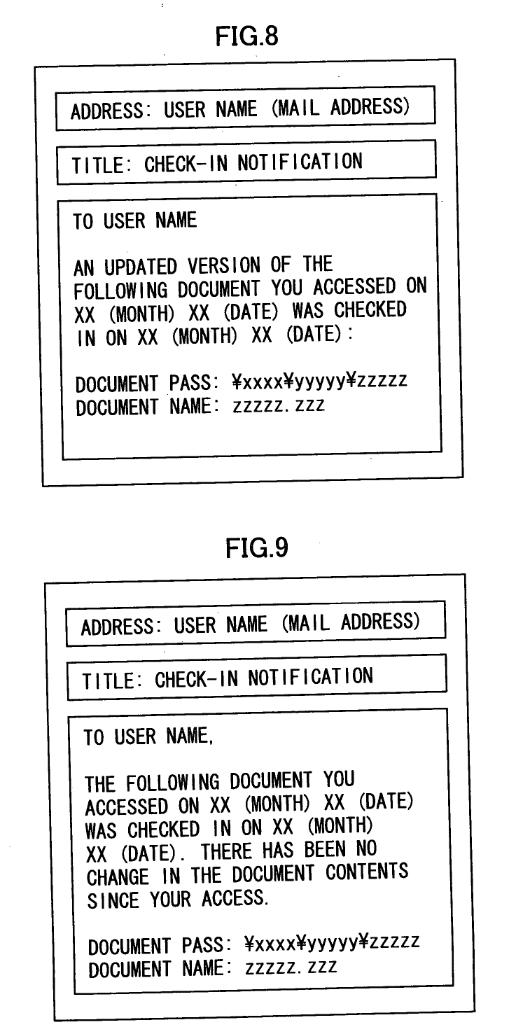

For example, FIG. 8 shows an image of e-mail contents when the document checked in has updated contents. FIG. 9 shows an image of e-mail contents when the document checked in has no updated contents.

As shown in FIGS. 8 and 9, an address is defined as the mail address of a user terminal set at the time of check-in notification setting. Atitle can be set arbitrarily; therefore, for example, “Check-in notification” is indicated. As shown in FIG. 8, the e-mail text includes an indication that the document has been checked in, an indication that the contents has been changed (for example, “updated version” indicated in FIG. 8), in addition, a document pass and a document name that are set for check-in notification. As shown in FIG. 9, the e-mail text includes an indication that the document has been checked in, an indication that the contents has not been changed, in addition, the document pass and the document name that are set for check-in notification.

In this way, when a shared document being checked out has been checked in, the competing user terminal 20-2 can be notified that the document has been checked in.

### (A-3) Effect of the Embodiment

According to the embodiment described above, in a case where a different user makes a check-out request for a file being checked out, when the file has been checked in, the user can be automatically provided, if the user requires, with notification indicating that the document has been checked in.

### (B) Another Embodiment

(B-1) The above embodiment has been described, referring to the case of application to a closed network. However, the application of the document management apparatus, the document management method, and the document management program according to the present invention is not limited to such a network, but widely applicable to an open network.

(B-2) In FIG. 1, the components (the terminal 20, the printer 31, the scanner 32, and the like) of the network each may include a radio communication apparatus in a predetermined radio method to perform radio communication. In addition, the document management system 1 may also be so configured to be capable of communication with a mobile communication terminal (for example, a cellular phone, a PHS, or the like).

(B-3) The above embodiment has been described, referring to the case where check-in notification is provided when a different user makes a check-out request for a file being checked out. However, in addition to notification provided when file competition has occurred, the document management apparatus 10 may also provide, when a predefined file has been updated, notification that the predefined file has been updated.

In this case, the document management apparatus 10 may, by the use of the shared document management function 12c, store and monitor the document name or the folder name previously defined by the user to thereby provide notification that the file has been updated. Moreover, when a new file has been stored as a shared file, the document management apparatus 10 may also provide notification that a new file has been stored as a shared file. (B-4) The shared document management function 12c of the embodiment described above transmits to all the users the predefined contents as e-mail text contents at the time of check-in notification. Alternatively, the shared document management function 12c may transmit an e-mail with different contents to each user.

For example, at the time of check-in notification, property information of an updated file is attached to an e-mail for the user A, while the property information is not attached to an e-mail for the user B, which is thus provided with only an indication that the file has been updated.

What is claimed is:

1. A document management apparatus that manages a shared file to which access is permitted to a plurality of users: comprising a shared document management section which, when a shared file designated by a user has been checked in, provides check-in notification, to an address designated by the user, that the shared file has been checked in.

2. The document management apparatus according to claim 1, wherein, upon receiving an access request from a different user for a shared document being checked out, the shared document management section asks the different user whether or not the check-in notification is required.

3. The document management apparatus according to claim 1, wherein the shared document management section determines whether or not the shared file checked in has updated contents.

4. The document management apparatus according to claim 2, wherein the shared document management section determines whether or not the shared file checked in has updated contents.

5. The document management apparatus according to any of claims 1 to 3, wherein the shared document management section provides the check-in notification by e-mail.

6. A document management method that manages a shared file to which access is permitted to a plurality of users,
wherein, when a shared file designated by a user has been checked in, a shared document management section provides check-in notification, to an address designated by the user, that the shared file has been checked in.

7. A document management program for causing a document management apparatus which manages a shared file to which access is permitted to a plurality of users to function as a shared document management section which, when a shared file designated by a user has been checked in, provides check-in notification, to an address designated by the user, that the shared file has been checked in.
